(19) United States
(12) Patent Application Publication
(10) Pub. No.: US 2023/0360599 A1
(43) Pub. Date: Nov. 9, 2023

(54) PIXEL DRIVE CIRCUIT, CONTROL METHOD THEREOF AND DISPLAY PANEL

(71) Applicant: BOE Technology Group Co., Ltd., Beijing (CN)

(72) Inventors: Libin LIU, Beijing (CN); Mei LI, Beijing (CN)

(21) Appl. No.: 17/432,467

(22) PCT Filed: Feb. 25, 2021
(86) PCT No.: PCT/CN2021/077905

§ 371 Date: Aug. 19, 2021

(30) Foreign Application Priority Data
Mar. 2, 2020 (CN) 202010136752.6

(51) Int. Cl. G09G 3/3233; G09G 3/3291

(52) U.S. Cl. CPC G09G 3/3233; G09G 3/3291; G09G 2300/0426; G09G 2310/061

(57) ABSTRACT

A pixel drive circuit, a control method thereof and a display panel. The pixel drive circuit comprises a reset module (5), the reset module (5) comprises a double-gate first transistor (T1) and a second transistor (T2), a first electrode of the double-gate first transistor (T1) is electrically connected to an initial signal line, a second electrode of the double-gate first transistor (T1) is electrically connected to a first node (n1); a first electrode of the second transistor (T2) is electrically connected to an intermediate node (n5) of the double-gate first transistor (T1), a second electrode of the second transistor (T2) is electrically connected to an anode of a light-emitting diode (6); two control electrodes of the double-gate first transistor (T1) and control electrode of the second transistor (T2) are electrically connected to a reset signal line; the second transistor and part of the double-gate first transistor constitute a double-gate transistor.

The disclosure claims the priority of a Chinese patent application filed in the China National Intellectual Property Administration on Mar. 2, 2020 with application number 202010136752.6 and application name “Pixel Drive Circuit, Control Method thereof and Display Panel”, the entire contents of which are hereby incorporated by reference.

### TECHNICAL FIELD

The disclosure relates to the technical field of display, in particular to a pixel drive circuit, a control method thereof and a display panel.

### BACKGROUND

With the continuous development of technology, people's demand for the performance of low-frequency organic light-emitting diode (OLED) display panels is increasing.

### SUMMARY

The embodiments of the disclosure provide a pixel drive circuit, a control method thereof and a display panel.

The embodiments of the disclosure adopt the technical solution as follows.

In an aspect, a pixel drive circuit for driving a light-emitting diode to emit light is provided, comprising a reset module, and the reset module comprises a double-gate first transistor and a second transistor.

A first electrode of the double-gate first transistor is electrically connected to an initial signal line, a second electrode of the double-gate first transistor is electrically connected to a first node, a first electrode of the second transistor is electrically connected to an intermediate node of the double-gate first transistor, and a second electrode of the second transistor is electrically connected to an anode of the light-emitting diode.

Two control electrodes of the double-gate first transistor and a control electrode of the second transistor are electrically connected to a reset signal line; the reset module is configured to reset the first node and the anode of the light-emitting diode by using an initial signal of the initial signal line under the control of a reset signal of the reset signal line.

The second transistor and part of the double-gate first transistor constitute a double-gate transistor.

Optionally, a driving module electrically connected to the first node, a second node and a third node and configured to activate a path between the second node and the third node under the control of the voltage of the first node, and generate a current for the light-emitting diode to emit light in the path.

Optionally, a first light emission control module and a second light emission control module;
wherein the first light emission control module is electrically connected to a light emission control signal line, the second node and the anode, the second light emission control module is electrically connected to the light emission control signal line, a voltage signal line and the third node, and
the first light emission control module and the second light emission control module are configured to transmit the current for the light-emitting diode to emit light to the anode under the control of a light emission control signal of the light emission control signal line.

Optionally, a driving control module electrically connected to a gate driving signal line, a data signal line and the third node and configured to write a data signal of the data signal line into the third node under the control of a gate driving signal of the gate driving signal line.

Optionally, the driving module comprises a double-gate third transistor, a fourth transistor and a storage capacitor.

Two control electrodes of the double-gate third transistor are electrically connected to the gate driving signal line, a first electrode of the double-gate third transistor is electrically connected to the first node, and a second electrode of the double-gate third transistor is electrically connected to the second node; a control electrode of the fourth transistor is electrically connected to the first node, a first electrode of the fourth transistor is electrically connected to the second node, and a second electrode of the fourth transistor is electrically connected to the third node; and a first end of the storage capacitor is electrically connected to the voltage signal line, and a second end of the storage capacitor is electrically connected to the first node.

Optionally, the first light emission control module comprises a fifth transistor, a control electrode of the fifth transistor is electrically connected to the light emission control signal line, a first electrode of the fifth transistor is electrically connected to the anode, and a second electrode of the fifth transistor is electrically connected to the second node.

Optionally, the second light emission control module comprises a sixth transistor, a control electrode of the sixth transistor is electrically connected to the light emission control signal line, a first electrode of the sixth transistor is electrically connected to the third node, and a second electrode of the sixth transistor is electrically connected to the voltage signal line.

Optionally, the driving control module comprises a seventh transistor, a control electrode of the seventh transistor is electrically connected to the gate driving signal line, a first electrode of the seventh transistor is electrically connected to the third node, and a second electrode of the seventh transistor is electrically connected to the data signal line.

Optionally, the double-gate first transistor, the second transistor, the double-gate third transistor, the fourth transistor, the fifth transistor, the sixth transistor and the seventh transistor are all P-type thin film transistors.

Optionally, the double-gate first transistor, the second transistor, the double-gate third transistor, the fourth transistor, the fifth transistor, the sixth transistor and the seventh transistor are all P-type low temperature poly-silicon-thin film transistors.

Optionally, the double-gate first transistor and the second transistor are N-type oxide thin film transistors, and the double-gate third transistor, the fourth transistor, the fifth transistor, the sixth transistor and the seventh transistor are all P-type low temperature poly-silicon-thin film transistors.

Optionally, the light-emitting diode is an organic light-emitting diode or a miniature light-emitting diode.

In another aspect, a display panel is provided, comprising the above pixel drive circuit.

In yet another aspect, a control method for controlling the above pixel drive circuit is provided. A double-gate third transistor, a fourth transistor, a fifth transistor, a sixth transistor and a seventh transistor are all P-type thin film transistors. The method comprises:
in a first period, inputting a light emission control signal with a first level to a light emission control signal line, a gate driving signal with the first level to a gate driving signal line, a first reset signal to a reset signal line to turn on a double-gate third transistor and a second transistor, a data signal with the first level to a data signal line, a voltage signal with the first level to a voltage signal line, and a voltage signal with the second level to an initial signal line;
in a second period, inputting the light emission control signal with the first level to the light emission control signal line, the gate driving signal with the second level to the gate driving signal line, a second reset signal to the reset signal line to turn off the double-gate third transistor and the second transistor, the data signal with the first level to the data signal line, the voltage signal with the first level to the voltage signal line, and the voltage signal with the second level to the initial signal line;
in a third period, inputting the light emission control signal with the second level to the light emission control signal line, the gate driving signal with the first level to the gate driving signal line, the second reset signal to the reset signal line to turn off the double-gate third transistor and the second transistor, the data signal with the first level to the data signal line, the voltage signal with the first level to the voltage signal line, and the voltage signal with the second level to the initial signal line; and
the voltage value of the first level is greater than that of the second level.

Optionally, the double-gate first transistor and the second transistor are P-type thin film transistors, the first reset signal is a reset signal with the second level and the second reset signal is a reset signal with the first level, the method further comprises:
in a first period, inputting a reset signal with the second level to a reset signal line;
in a second period, inputting the reset signal with the first level to the reset signal line; and
in a third period, inputting the reset signal with the first level to the reset signal line.

Optionally, when the double-gate first transistor and the second transistor are N-type thin film transistors, the first reset signal is a reset signal with the first level and the second reset signal is a reset signal with the second level, the method further comprises:
in a first period, inputting a reset signal with a first level to a reset signal line;
in a second period, inputting a reset signal with a second level to the reset signal line; and
in a third period, inputting the reset signal with the second level to the reset signal line.

The disclosure provides a computing processing device, comprising:
a memory in which computer readable codes are stored; and
one or more processors, wherein when the computer readable codes are executed by the one or more processors, the computing processing device executes the above control method.

The disclosure provides a computer program comprising computer readable codes which, when run on a computing processing device, cause the computing processing device to implement the above control method.

The disclosure provides a computer readable medium in which the above computer program is stored.

The above description is only an overview of the technical solution of this disclosure, which may be implemented according to the contents of the specification in order to understand the technical means of this disclosure more clearly, and in order to make the above and other objects, features and advantages of this disclosure more obvious and understandable, the detailed description of this disclosure will be given below.

### BRIEF DESCRIPTION OF THE DRAWINGS

In order to explain the technical solution in the embodiments of the disclosure or the related art more clearly, the drawings used in the description of the embodiments or related arts will be briefly introduced below. Obviously, the drawings in the following description are only some embodiments of the disclosure, and for those of ordinary skill in the art, other drawings may be obtained according to these drawings without creativity.

FIG. 1 is a circuit diagram of a pixel drive circuit provided by an embodiment of the disclosure;

FIG. 2 is a signal timing diagram of a pixel drive circuit provided by an embodiment of the disclosure;

FIG. 3 is a pixel drive circuit diagram in the related art;

FIG. 4 is a pixel drive circuit diagram provided by an embodiment of the disclosure;

FIG. 5 schematically shows a block diagram of a computing processing device for executing the method according to the disclosure; and

FIG. 6 schematically shows a storage unit for holding or carrying program codes for implementing the method according to the disclosure.

### DETAILED DESCRIPTION

The technical solution in the embodiments of the disclosure will be clearly and completely described below with reference to the drawings in the embodiments of the disclosure. Obviously, the described embodiments are only part of the embodiments of the disclosure, not all of the embodiments. Based on the embodiments in the disclosure, all other embodiments obtained by those of ordinary skill in the art without creative labor are within the scope of protection of the disclosure.

In the embodiments of the disclosure, the words such as “first”, “second” . . . “seventh” are configured to distinguish the same items or similar items with basically the same function and effect, and they are only to clearly describe the technical solution of the embodiments of the disclosure, but not to be understood as indicating or implying relative importance or implicitly indicating the number of indicated technical features.

In the embodiments of the disclosure, a gate of a transistor is called a control electrode, and one of a source and a drain is called a first electrode and the other a second electrode. In the embodiments of the disclosure, the first electrodes of all transistors are called drains and the second electrodes are called sources.

A pixel drive circuit for driving a light-emitting diode to emit light comprises:
a double-gate first transistor and a second transistor, wherein the double-gate first transistor has a first electrode electrically connected to an initial signal line, a second electrode electrically connected to a first node, and two gates electrically connected to a reset signal line; the second transistor has a first electrode electrically connected to the initial signal line, a second electrode electrically connected to an anode of the light-emitting diode, and a gate electrically connected to a gate driving signal line;
a double-gate third transistor, a fourth transistor and a storage capacitor, wherein the double-gate third transistor has two control electrodes electrically connected to the gate driving signal line, a first electrode electrically connected to the first node, and a second electrode electrically connected to a second node; the fourth transistor has a control electrode electrically connected to the first node, a first electrode electrically connected to the second node, and a second electrode electrically connected to a third node; the storage capacitor has a first end electrically connected to a voltage signal line, and a second end electrically connected to the first node;
a fifth transistor and a sixth transistor, wherein the sixth transistor has a control electrode electrically connected to a light emission control signal line, a first electrode electrically connected to the third node, and a second electrode electrically connected to the voltage signal line; the fifth transistor has a control electrode electrically connected to the light emission control signal line, a first electrode electrically connected to the anode, and a second electrode electrically connected to the second node; and
a seventh transistor, wherein the seventh transistor has a control electrode electrically connected to the gate driving signal line, a first electrode electrically connected to the third node, and a second electrode electrically connected to a data signal line.

The pixel drive circuit may be used for driving the light-emitting diode to emit light. However, when a display panel comprising the pixel drive circuit is used for low-frequency display, the anode voltage of the light-emitting diode is high, the anode, the second transistor and the initial signal line tend to form a leakage path, that is, electric leakage occurs, and the leakage amount increases with the prolongation of low-frequency time, thus seriously affecting the display effect.

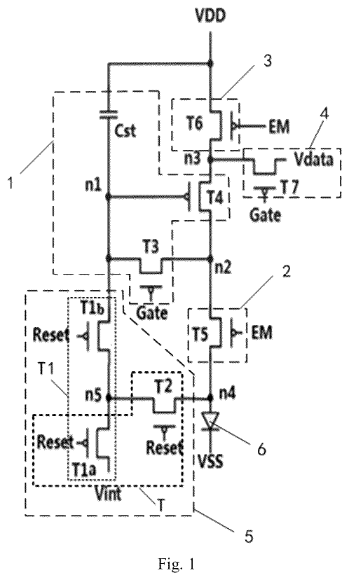

On the basis of the above, the disclosure provides a pixel drive circuit for driving a light-emitting diode to emit light. As shown in FIG. 1, the pixel drive circuit comprises a reset module 5.

The reset module 5 comprises a double-gate first transistor T1 and a second transistor T2, a first electrode of the double-gate first transistor T1 is electrically connected to an initial signal line Vint, and a second electrode of the double-gate first transistor T1 is electrically connected to a first node n1; a first electrode of the second transistor T2 is electrically connected to an intermediate node n5 of the double-gate first transistor T1, and a second electrode of the second transistor T2 is electrically connected to an anode; two control electrodes of the double-gate first transistor T1 and a control electrode of the second transistor T2 are electrically connected to a reset signal line Reset; and the reset module 5 is configured to reset the first node n1 and the anode of the light-emitting diode 6 by using an initial signal of the initial signal line Vint under the control of a reset signal of the reset signal line Reset;
wherein the second transistor T2 and part of the double-gate first transistor T1 constitute a double-gate transistor.

Optionally, the pixel drive circuit further comprises a driving module 1 electrically connected to the first node n1, a second node n2 and a third node n3 and configured to activate a path between the second node n2 and the third node n3 under the control of the voltage of the first node n1, and generate a current for the light-emitting diode 6 to emit light in the path.

Optionally, the pixel drive circuit further comprises a first light emission control module 2 and a second light emission control module 3, wherein the first light emission control module 2 is electrically connected to a light emission control signal line EM, the second node n2 and the anode of the light-emitting diode 6, the second light emission control module 3 is electrically connected to the light emission control signal line EM, a voltage signal line VDD and the third node n3, and the first light emission control module 2 and the second light emission control module 3 are configured to transmit the current for the light-emitting diode 6 to emit light to the anode under the control of a light emission control signal of the light emission control signal line EM.

Optionally, the pixel drive circuit further comprises a driving control module 4 electrically connected to a gate driving signal line Gate, a data signal line Vdata and the third node n3 and configured to write a data signal of the data signal line Vdata into the third node n3 under the control of a gate driving signal of the gate driving signal line Gate.

The specific circuit structures included in the driving module, the first light emission control module, the second light emission control module and the driving control module are not limited, as long as corresponding functions may be realized.

Referring to FIG. 1, the double-gate first transistor T1 comprises two single-gate transistors T1a and T1b connected in series. The second transistor T2 is a single-gate transistor, which may form a new double-gate transistor T with the single-gate transistor T1a, and in this case, the single-gate transistor T1a and the single-gate transistor T1b may still constitute the double-gate first transistor T1.

Here, the types of the above double-gate first transistor and second transistor are not limited, they may be thin film transistors, field effect transistors, etc., and the former is mostly used at present.

Here, the sizes of the above double-gate first transistor and second transistor are not limited. For example, the double-gate first transistor may be a tube with a width-length ratio of 3 um/(3+3) um, and in this case, the double-gate transistor composed of the second transistor and the single-gate transistor T1a may be a tube with a width-length ratio of 3 um/(3+3) um.

The first node, the second node and the third node are only defined to facilitate the description of the circuit structure, and the first node, the second node and the third node are not actual circuit units.

The first electrode of the second transistor T2 is called drain (D), the second electrode is called source (D), and the control electrode is called gate (G).

Referring to FIG. 1, a cathode of the light-emitting diode 6 may be electrically connected to a ground terminal VSS.

In this way, the first electrode of the second transistor in the reset module is electrically connected to the intermediate node of the double-gate first transistor, and the two control electrodes of the double-gate first transistor and the control electrode of the second transistor are electrically connected to the reset signal line, so that the second transistor and part of the double-gate first transistor form the double-gate transistor; and the double-gate transistor may greatly reduce the leakage of the anode, thus reducing the influence of anode leakage on the display effect, so that product quality is improved.

Besides, a double-gate structure of the second transistor may be realized by adding one transistor, but this will undoubtedly increase the layout space. In this disclosure, the second transistor and part of the double-gate first transistor constitute the double-gate transistor by using a common gate, without adding any tube.

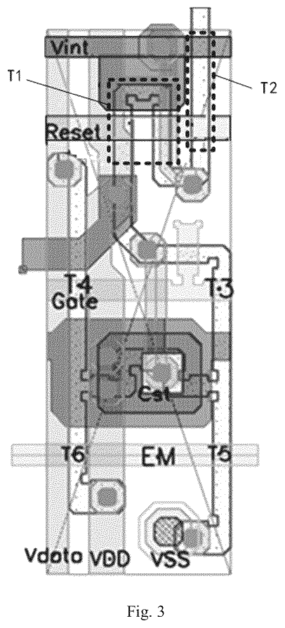

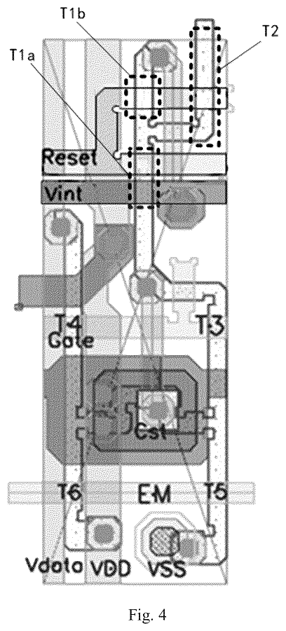

It may be concluded by comparing the layout of the embodiment in FIG. 3 with the layout of the disclosure in FIG. 4 that, in FIG. 3, the two transistors in the double-gate first transistor T1 and the second transistor T2 are horizontally arranged, the initial signal line Vint is disposed above the two transistors in the double-gate first transistor T1, and there is one reset signal line Reset which is electrically connected to the two transistors in the double-gate first transistor T1.

In FIG. 4, the second transistor T2 is connected between the transistor T1a and the transistor T1b, the transistor T1a and the transistor T1b are longitudinally arranged, the initial signal line Vint is arranged below the reset signal line Reset, and there are two reset signal lines Reset, one of which is electrically connected to the transistor T1a, and the other is electrically connected to the transistor T1b and the second transistor T2. The width-length ratio of the double-gate transistor composed of the transistor T1a and the transistor T1b is within the range of (2-4) um/[2+(2-4)] um, and the width-length ratio of the second transistor T2 is within the range of (2-4) um/(2-4) um. The second transistor and the transistor T1a constitute the double-gate transistor. Compared with FIG. 3, the connection positions and arrangement positions of the transistor T1a, the transistor T1b and the second transistor T2 in FIG. 4 are changed, and the relative positions of the initial signal line Vint and the reset signal line Reset are changed; the initial signal line Vint only needs to be electrically connected to the transistor T1a, but does not need to be electrically connected to the second transistor T2, thus saving some space; and although the number of the reset signal lines Reset is increased, the overall layout space is not increased because the arrangement space of the initial signal line Vint is reduced.

Therefore, the above pixel drive circuit does not increase the layout space or the size of existing products, so that it may be applied to high-resolution (HPPI) display panels.

Optionally, as shown in FIG. 1, the driving module 1 comprises a double-gate third transistor T3, a fourth transistor T4 and a storage capacitor Cst.

The double-gate third transistor T3 has two control electrodes electrically connected to the gate driving signal line Gate, a first electrode electrically connected to the first node n1, and a second electrode electrically connected to a second node n2; the fourth transistor T4 has a control electrode electrically connected to the first node n1, a first electrode electrically connected to the second node n2, and a second electrode electrically connected to a third node n3; and the storage capacitor Cst has a first end electrically connected to a voltage signal line VDD, and a second end electrically connected to the first node n1. It should be noted that in the double-gate third transistor T3 in FIG. 1, two single-gate transistors connected in series are not shown, but are replaced with a double-gate transistor.

Optionally, as shown in FIG. 1, the first light emission control module 2 comprises a fifth transistor T5, and the second light emission control module 3 comprises a sixth transistor T6.

The sixth transistor T6 has a control electrode electrically connected to a light emission control signal line EM, a first electrode electrically connected to the third node n3, and a second electrode electrically connected to the voltage signal line VDD; and the fifth transistor T5 has a control electrode electrically connected to the light emission control signal line EM, a first electrode electrically connected to the anode, and a second electrode electrically connected to the second node n2. In FIG. 1, the first electrode of the fifth transistor T5 and the second electrode of the second transistor T2 may be electrically connected to a fourth node n4, and the fourth node n4 is electrically connected to the anode of the light-emitting diode.

Optionally, as shown in FIG. 1, the driving control module 4 comprises a seventh transistor T7, and the seventh transistor T7 has a control electrode electrically connected to the gate driving signal line Gate, a first electrode electrically connected to the third node n3, and a second electrode electrically connected to a data signal line Vdata.

Optionally, the double-gate first transistor, the second transistor, the double-gate third transistor, the fourth transistor, the fifth transistor, the sixth transistor and the seventh transistor are all P-type thin film transistors.

Further optionally, the double-gate first transistor, the second transistor, the double-gate third transistor, the fourth transistor, the fifth transistor, the sixth transistor and the seventh transistor are all P-type low temperature poly-silicon-thin film transistors (LTPS-TFT). The low temperature poly-silicon-thin film transistors have higher electron mobility and shorter response time.

Optionally, the double-gate first transistor and the second transistor are N-type oxide thin film transistors, and the double-gate third transistor, the fourth transistor, the fifth transistor, the sixth transistor and the seventh transistor are all P-type low temperature poly-silicon-thin film transistors.

The above oxide thin film transistor may be an Indium Gallium Zinc Oxide (IGZO) thin film transistor, Indium Tin Oxide (ITO), Indium Zinc Oxide (IZO), etc. The IGZO thin film transistor is mostly used in practice for its good performance.

Optionally, the above light-emitting diode is an organic light-emitting diode (OLED) or a miniature light-emitting diode.

The miniature light-emitting diode here includes a Mini LED and a Micro LED.

It should be noted that if the pixel drive circuit is applied to an OLED display panel, the light-emitting diode is an organic light-emitting diode, and if the pixel drive circuit is applied to a Mini LED display panel or a Micro LED display panel, the light-emitting diode is a Mini LED or a Micro LED.

An embodiment of the disclosure provides a display panel comprising the pixel drive circuit of the above embodiment.

The above display panel may be a flexible display panel (also called a flexible screen) or a rigid display panel (i.e., a display panel that may not be bent), which is not limited here.

The above display panel may be an organic light-emitting diode (OLED) display panel, a Micro LED display panel or a Mini LED display panel, and any products or components with a display function such as televisions, digital cameras, mobile phones, and tablet computers comprising these display panels.

The above display panel is characterized by small anode leakage, a good display effect and high product quality.

An embodiment of the disclosure provides a control method for controlling the pixel drive circuit shown in FIG. 1. It should be noted that the control method may be applied to the case where the double-gate first transistor and the second transistor are both P-type thin film transistors or N-type thin film transistors, the double-gate third transistor, the fourth transistor, the fifth transistor, the sixth transistor and the seventh transistor are all P-type thin film transistors, a first level is high and a second level is low.

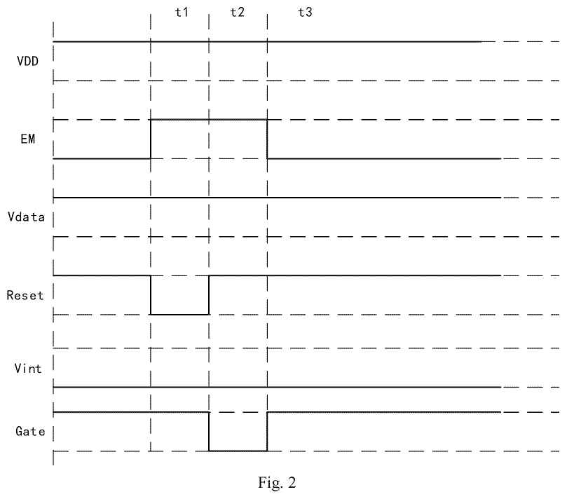

Under the condition that the double-gate first transistor, the second transistor, the double-gate third transistor, the fourth transistor, the fifth transistor, the sixth transistor and the seventh transistor are all P-type thin film transistors, the control method comprises the following steps:
S01, referring to FIG. 2, in a first period t1, inputting a light emission control signal with a first level to a light emission control signal line EM, a gate driving signal with the first level to a gate driving signal line Gate, a reset signal with a second level to a reset signal line Reset, a data signal with the first level to a data signal line Vdata, a voltage signal with the first level to a voltage signal line VDD, and a voltage signal with the second level to an initial signal line Vint;
wherein in the first period t1, the double-gate first transistor and the second transistor are turned on, and the potential of the initial signal line Vint resets the gate of the fourth transistor T4 and the anode of the light-emitting diode; the gate of the fourth transistor T4 is reset to a low level because the initial signal line inputs a low level, and the P-type thin film transistor may be turned on at a low level, so the fourth transistor T4 is turned on; the double-gate third transistor, the fifth transistor, the sixth transistor and the seventh transistor are turned off; and this stage may be called initialization stage;
S02, referring to FIG. 2, in a second period t2, inputting the light emission control signal with the first level to the light emission control signal line EM, the gate driving signal with the second level to the gate driving signal line Gate, the reset signal with the first level to the reset signal line Reset, the data signal with the first level to the data signal line Vdata, the voltage signal with the first level to the voltage signal line VDD, and the voltage signal with the second level to the initial signal line Vint;
wherein in the second period t2, the double-gate third transistor and the seventh transistor are turned on, and the gate of the fourth transistor T4 is written with Vdata+Vth voltage and then turned off; at this point, the voltage of the first node n1 is also Vdata+Vth, where Vth is the threshold voltage of the fourth transistor; the double-gate first transistor, the second transistor, the fifth transistor and the sixth transistor are turned off; this stage may be called compensation stage; and
S03, referring to FIG. 2, in a third period t3, inputting the light emission control signal with the second level to the light emission control signal line EM, the gate driving signal with the first level to the gate driving signal line Gate, the reset signal with the first level to the reset signal line Reset, the data signal with the first level to the data signal line Vdata, the voltage signal with the first level to the voltage signal line VDD, and the voltage signal with the second level to the initial signal line Vint; wherein the voltage value of the first level is greater than that of the second level;
in the third period t3, the fourth transistor, the fifth transistor and the sixth transistor are turned on, and the double-gate first transistor, the second transistor, the double-gate third transistor and the seventh transistor are turned off; at this point, the current input by the voltage signal line VDD flows into the anode of the light-emitting diode, thereby driving the light-emitting diode to emit light; and this stage may be called light emitting stage.

The data signal line is required to be at a high level in the second period t2, and there is no requirement for the other two periods. The above control method and FIG. 4 are explained by assuming that the data signal line is at a high level in all the three periods.

It should be noted that the conduction conditions of N-type thin film transistors and P-type thin film transistors are different, the former is turned on at a high level of the gate, and the latter is turned on at a low level of the gate. Therefore, for the control method of the pixel drive circuit in which the double-gate first transistor and the second transistor are N-type thin film transistors and the double-gate third transistor, the fourth transistor, the fifth transistor, the sixth transistor and the seventh transistor are all P-type thin film transistors, it is only necessary to adjust the levels of the reset signals input by the gates of the double-gate first transistor and the second transistor in different periods. Other aspects are the same as those in the above control method, so they will not be repeated here.

Specifically, for the pixel drive circuit in which the double-gate first transistor and the second transistor are N-type thin film transistors and the double-gate third transistor, the fourth transistor, the fifth transistor, the sixth transistor and the seventh transistor are all P-type thin film transistors, the control method adjusts the level of the reset signal as follows:
in a first period, inputting a reset signal with a first level to a reset signal line;
in a second period, inputting a reset signal with a second level to the reset signal line; and
in a third period, inputting the reset signal with the second level to the reset signal line.

In this way, the light-emitting diode in the pixel drive circuit may also be controlled to emit light.

The embodiments of the disclosure provide a control method by which the pixel drive circuit may drive the light-emitting diode to emit light. The control method is simple and easy to realize.

The various part embodiments of the disclosure may be implemented in hardware, or in software modules running on one or more processors, or in a combination thereof. It should be understood by those skilled in the art that a microprocessor or a digital signal processor (DSP) may be used in practice to realize some or all of the functions of some or all of the parts in the computing equipment according to embodiments of the disclosure. The disclosure may also be implemented as an equipment or apparatus program (e.g., a computer program and a computer program product) for implementing part of or the whole method described herein. Such a program implementing the disclosure may be stored on a computer readable medium, or may have the form of one or more signals. Such signals may be downloaded from the Internet, or provided on carrier signals, or in any other form.

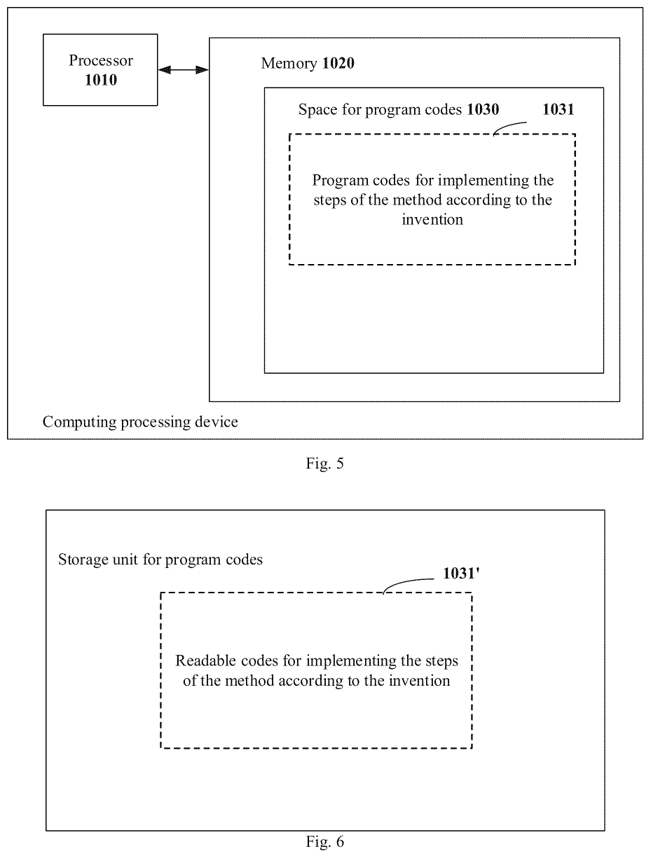

For example, FIG. 5 shows a computing processing device which may implement the method according to the disclosure. The computing processing device conventionally comprises a processor 1010 and a computer program product or computer readable medium in the form of a memory 1020. The memory 1020 may be an electronic memory such as flash memory, EEPROM (electrically erasable programmable read only memory), EPROM, hard disk or ROM. The memory 1020 has storage spaces 1030 for program codes 1031 for executing any step in the above method. For example, the storage spaces 1030 for the program codes may contain various program codes 1031 for implementing the steps in the above method. These program codes may be read from or written into one or more computer program products. These computer program products include program code carriers such as hard disk, compact disk (CD), memory card or floppy disk. Such a computer program product is usually a portable or fixed storage unit as described with reference to FIG. 6. The storage unit may have memory segments, memory spaces, and the like arranged similarly to the memory 1020 in the computing processing device of FIG. 5. The program codes may be compressed in an appropriate form, for example. Generally, the storage unit contains computer readable codes 1031′, i.e., codes readable by, for example, a processor such as 1010, which, when run by the computing processing device, cause the computing processing device to implement the steps in the method described above.

As used herein, “one embodiment”, “embodiment” or “one or more embodiments” means that a particular feature, structure or characteristic described in connection with an embodiment is included in at least one embodiment of the disclosure. In addition, please note that the word examples of “in one embodiment” here do not necessarily all refer to the same embodiment.

In the specification provided herein, numerous specific details are set forth. However, it should be understood that the embodiments of the disclosure may be practiced without these specific details. In some instances, well-known methods, structures, and techniques have not been shown in detail so as not to obscure the understanding of the specification.

In the Claims, any reference signs placed between parentheses shall not be construed as limiting the Claims. The word “comprise” does not exclude the presence of elements or steps not listed in a Claim. The word “a” or “an” preceding an element does not exclude the presence of a plurality of such elements. The disclosure may be realized by means of hardware comprising several different elements and by means of a suitably programmed computer. In a unit Claim enumerating several means, several of these means may be embodied by one and the same item of hardware. The use of words first, second, third, etc. does not indicate any order. These words may be interpreted as names.

The above are only specific embodiments of the disclosure, but the protection scope of the disclosure is not limited thereto. Anyone skilled in the art may easily think of changes or substitutions within the technical scope disclosed in the disclosure, which should be covered within the protection scope of the disclosure. Therefore, the protection scope of the disclosure shall be subject to the protection scope of the Claims.

1. A pixel drive circuit for driving a light-emitting diode to emit light, comprising a reset module, wherein the reset module comprises a double-gate first transistor and a second transistor;
a first electrode of the double-gate first transistor is electrically connected to an initial signal line, a second electrode of the double-gate first transistor is electrically connected to a first node, a first electrode of the second transistor is electrically connected to an intermediate node of the double-gate first transistor, and a second electrode of the second transistor is electrically connected to an anode of the light-emitting diode;
two control electrodes of the double-gate first transistor and a control electrode of the second transistor are electrically connected to a reset signal line; the reset module is configured to reset the first node and the anode of the light-emitting diode by using an initial signal of the initial signal line under the control of a reset signal of the reset signal line; and
the second transistor and part of the double-gate first transistor constitute a double-gate transistor.

2. The pixel drive circuit according to claim 1, further comprising:
a driving module electrically connected to the first node, a second node and a third node and configured to activate a path between the second node and the third node under the control of the voltage of the first node, and generate a current for the light-emitting diode to emit light in the path.

3. The pixel drive circuit according to claim 2, further comprising: a first light emission control module and a second light emission control module;
wherein the first light emission control module is electrically connected to a light emission control signal line, the second node and the anode, the second light emission control module is electrically connected to the light emission control signal line, a voltage signal line and the third node, and
the first light emission control module and the second light emission control module are configured to transmit the current for the light-emitting diode to emit light to the anode under the control of a light emission control signal of the light emission control signal line.

4. The pixel drive circuit according to claim 3, further comprising:
a driving control module electrically connected to a gate driving signal line, a data signal line and the third node and configured to write a data signal of the data signal line into the third node under the control of a gate driving signal of the gate driving signal line.

5. The pixel drive circuit according to claim 4, wherein the driving module comprises a double-gate third transistor, a fourth transistor and a storage capacitor;
two control electrodes of the double-gate third transistor are electrically connected to the gate driving signal line, a first electrode of the double-gate third transistor is electrically connected to the first node, and a second electrode of the double-gate third transistor is electrically connected to the second node; a control electrode of the fourth transistor is electrically connected to the first node, a first electrode of the fourth transistor is electrically connected to the second node, and a second electrode of the fourth transistor is electrically connected to the third node; and a first end of the storage capacitor is electrically connected to the voltage signal line, and a second end of the storage capacitor is electrically connected to the first node.

6. The pixel drive circuit according to claim 5, wherein the first light emission control module comprises a fifth transistor,
a control electrode of the fifth transistor is electrically connected to the light emission control signal line, a first electrode of the fifth transistor is electrically connected to the anode, and a second electrode of the fifth transistor is electrically connected to the second node.

7. The pixel drive circuit according to claim 6, wherein the second light emission control module comprises a sixth transistor,
a control electrode of the sixth transistor is electrically connected to the light emission control signal line, a first electrode of the sixth transistor is electrically connected to the third node, and a second electrode of the sixth transistor is electrically connected to the voltage signal line.

8. The pixel drive circuit according to claim 7, wherein the driving control module comprises a seventh transistor, a control electrode of the seventh transistor is electrically connected to the gate driving signal line, a first electrode of the seventh transistor is electrically connected to the third node, and a second electrode of the seventh transistor is electrically connected to the data signal line.

9. The pixel drive circuit according to claim 8, wherein the double-gate first transistor, the second transistor, the double-gate third transistor, the fourth transistor, the fifth transistor, the sixth transistor and the seventh transistor are all P-type thin film transistors.

10. The pixel drive circuit according to claim 9, wherein the double-gate first transistor, the second transistor, the double-gate third transistor, the fourth transistor, the fifth transistor, the sixth transistor and the seventh transistor are all P-type low temperature poly-silicon-thin film transistors.

11. The pixel drive circuit according to claim 8, wherein the double-gate first transistor and the second transistor are N-type oxide thin film transistors, and the double-gate third transistor, the fourth transistor, the fifth transistor, the sixth transistor and the seventh transistor are all P-type low temperature poly-silicon-thin film transistors.

12. The pixel drive circuit according to claim 1, wherein the light-emitting diode is an organic light-emitting diode or a miniature light-emitting diode.

13. A display panel, comprising the pixel drive circuit according to claim 1.

14. The display panel according to claim 13, wherein the display panel is an organic light-emitting diode display panel, a Micro LED display panel or a Mini LED display panel.

15. A control method for controlling the pixel drive circuit according to claim 8, wherein a double-gate third transistor, a fourth transistor, a fifth transistor, a sixth transistor and a seventh transistor are all P-type thin film transistors, and the method comprises:
in a first period, inputting a light emission control signal with a first level to a light emission control signal line, a gate driving signal with the first level to a gate driving signal line, a first reset signal to a reset signal line to turn on a double-gate third transistor and a second transistor, a data signal with the first level to a data signal line, a voltage signal with the first level to a voltage signal line, and a voltage signal with the second level to an initial signal line;
in a second period, inputting the light emission control signal with the first level to the light emission control signal line, the gate driving signal with the second level to the gate driving signal line, a second reset signal to the reset signal line to turn off the double-gate third transistor and the second transistor, the data signal with the first level to the data signal line, the voltage signal with the first level to the voltage signal line, and the voltage signal with the second level to the initial signal line;
in a third period, inputting the light emission control signal with the second level to the light emission control signal line, the gate driving signal with the first level to the gate driving signal line, the second reset signal to the reset signal line to turn off the double-gate third transistor and the second transistor, the data signal with the first level to the data signal line, the voltage signal with the first level to the voltage signal line, and the voltage signal with the second level to the initial signal line; and
the voltage value of the first level is greater than that of the second level.

16. The control method according to claim 15, wherein when the double-gate first transistor and the second transistor are P-type thin film transistors, the first reset signal is a reset signal with the second level and the second reset signal is a reset signal with the first level, the method further comprises:
in a first period, inputting a reset signal with the second level to a reset signal line;
in a second period, inputting the reset signal with the first level to the reset signal line; and
in a third period, inputting the reset signal with the first level to the reset signal line.

17. The control method according to claim 15, wherein when the double-gate first transistor and the second transistor are N-type thin film transistors, the first reset signal is a reset signal with the first level and the second reset signal is a reset signal with the second level, the method further comprises:
in a first period, inputting a reset signal with a first level to a reset signal line;
in a second period, inputting a reset signal with a second level to the reset signal line; and
in a third period, inputting the reset signal with the second level to the reset signal line.

18. A computing processing device, comprising:
a memory in which computer readable codes are stored; and
one or more processors, wherein when the computer readable codes are executed by the one or more processors, the computing processing device executes the control method according to claim 15.

19. A computer program, comprising computer readable codes which, when run on a computing processing device, cause the computing processing device to implement the control method according to claim 15.

20. A computer readable medium in which the computer program according to claim 19 is stored.
